(19) United States
(12) Patent Application Publication
(10) Pub. No.: US 2006/0190523 A1
(43) Pub. Date: Aug. 24, 2006

(54) Network match maker

(76) Inventor: Parag Jasani, Mumbai (IN)

Correspondence Address: Parag Jasani, 103, Mont Blanc, 550, Jame Jamshed, Road, Matunga, Mumbai, Maharashtra, 400019, IN

(21) Appl. No.: 11/357,010

(22) Filed: Feb. 21, 2006

Related U.S. Application Data
(60) Provisional application No. 60/654,891, filed on Feb. 22, 2005.

(51) Int. Cl. G06F 15/16

(52) U.S. Cl. 709/201

(57) ABSTRACT

The present invention relates to a method and a system for facilitating an exchange of information between at least two parties on an electronic network comprising of at least a server and plurality of clients. The network contains at least one of the parties' desired, own or both attributes and at least one of the remaining parties' own, desired or both attributes. The invention searches these attributes of one party from the attributes of the other or plurality of other parties. If at least one desired, own or both attributes of one party matches at least one own, desired or both attributes of the other or plurality of other parties respectively, then transmitting notifications identifying the other or a plurality of matched parties to the one party. Similarly, notifications identifying the one party are substantially simultaneously transmitted to other or plurality of matched parties.

### CROSS REFERENCE TO RELATED APPLICATION

This application claims benefit from the US Provisional Application No. 60/654,891 filed on Feb. 22, 2005.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

Millions of people all over the world are using dating and matrimonial matchmaking web sites on the Internet to search for their preferred dating partner or a life partner. One of the main advantages of matchmaking websites on the Internet is that it facilitates anonymous communications with people without any geographical barriers, while using sophisticated matchmaking tools.

Typically, these matchmaking web sites have four sections: 1) member profile submission, 2) preferred partner information submission, 3) search & matchmaking features and 4) communication tools, to facilitate a complete ‘register, search & contact’ solution for their members.

Out of all, the communication is a very important feature, as it helps establish initial exchange of information and ideas, which can later be helpful in starting relationships.

To facilitate communication between their members, these websites offer (a) email, (b) chat (1-on-1 and chat-rooms) (c) direct contact display (like telephone numbers, postal addresses, etc.), and (d) instant messengers.

As communications on dating and matrimonial websites are (in most cases) anonymous, members can communicate to their heart's content without establishing direct physical contact between them, while having total control of the communication process (as in, offering controlled access to one's own email, chat or other means of communication).

Out of all the modes of communications mentioned above, Instant Messengers are most practical, as they offer instant, real-time, interactive & anonymous communication with preferred members.

Even when Instant Messengers are the best for such type of communications, their full potential is underutilized and remains untapped. The reason: Usually, on Instant Messenger, many members come online and go offline all the time. When a match seeker logs on, searching for members who match his/her preference(s), he/she can find and communicate with only those who are online at that particular time. To find more matches, he/she has to perform the search for his/her matches who are online, again and again, involving his/her time and effort. In other words, the members have to search for their matches (who are online) manually each time.

To illustrate the aforesaid,

FIG. 1a) shows a party/user manually searching for matches who are online.

The figure shows the party ‘ghi’ searching for matches who are online at three different occasions. Party 1, who is a match for party “ghi”, comes online before party “ghi” comes online and goes offline after party “ghi” goes offline. Party 2, who is also a match for party “ghi”, comes online before party “ghi” comes online and goes offline while party “ghi” is online. Parties 3 to 10, who are also matches for party “ghi”, come online and go offline at different times in the period when party “ghi” is online. Party “ghi” manually searches at 7:20 pm, 8:24 pm and 8:59 pm, which results into only five matches being found, i.e. Parties 1, 2, 3, 4 and 10. Even though party “ghi” is online between 7 pm and 9 pm, the period when Parties 1 to 10 are available online at different times, party “ghi” has missed the opportunity of communicating with Parties 5, 6, 7, 8 and 9.

The present invention obviates the aforesaid drawbacks by providing an automatic search once a party is available online and thereafter informing the said party and other matched party(ies) about their match(es) being online.

### BRIEF SUMMARY OF THE INVENTION

The present invention provides a system and a method of facilitating communication between parties on an electronic network, i.e. when the parties are available on the network (available online), with an interactive event driven alert system in which notifications are sent to the relevant matching parties based on their own, desired or both attributes, resulting in facilitating them to communicate with each other.

The present invention relates to a method and a system of facilitating an exchange of information between at least two parties on an electronic network, said network comprising of at least a server and plurality of clients as defined herein, said network containing at least one of said parties' desired, own or both attributes and at least one of the remaining parties' own, desired or both attributes, comprising the steps of i) searching at least desired, own or both attributes of one party from at least own, desired or both attributes of the other or a plurality of other parties' respectively; ii) if a) at least one desired attribute of said one party matches at least one own attribute of said other or a plurality of other parties; or b) at least one own attribute of said one party matches at least one desired attribute of said other or a plurality of other parties; or c) at least one desired attribute of said one party matches at least one own attribute of said other or a plurality of other parties and at least one own attribute of said one party matches at least one desired attribute of said other or a plurality of other parties, iii) then transmitting one or a plurality of notifications identifying said one or a plurality of matched parties to said one party.

A similar notification identifying the one party is substantially simultaneously transmitted to the other or a plurality of matched parties.

Further, the present invention relates to a method and system of facilitating an exchange of information between one party and other or plurality of other parties on an electronic network, said network comprising of at least a server and plurality of clients as defined herein, said network containing a pre-computed list of other or a plurality of other parties with at least one desired attribute of said one party matched with at least one own attribute of said other or a plurality of other parties; or at least one own attribute of said one party matched with at least one desired attribute of said other or a plurality of other parties; or at least one desired attribute of said one party matched with at least one own attribute of said other or a plurality of other parties and at least one own attribute of said one party matched with at least one desired attribute of said other or a plurality of other parties; or a combination thereof, wherein if at least said other or a plurality of said other parties on said list is available on said network, one or a plurality of notifications identifying said other or a plurality of matched parties is transmitted to said one party.

The exact nature of this invention, as well as its objectives and advantages, will become readily apparent upon reference to the following detailed description when considered in conjunction with the accompanying drawings, wherein the same numerals/characters designate like parts throughout the figures and wherein:

### BRIEF DESRIPTION OF THE SEVERAL VIEWS OF THE DRAWINGS

FIG. 1b is an illustration showing party “ghi” using the present invention for matching;

FIG. 2 is a flowchart showing party “xyz's” matchmaking and notification process;

FIG. 3 is an illustration showing that party “abc's” direct match is party “xyz”;

FIG. 4 is an illustration showing that party “def's” reverse match is party “xyz”;

FIG. 5 is an illustration showing that party “jkl” and party “mno” are cross matches of each other;

FIG. 6 is a flow chart showing the process of generating a pre-computed list of Party “xyz's” direct, reverse and cross matches;

FIG. 7 is a flowchart showing party “xyz's” matchmaking and notification process using a pre-computed list.

### DETAILED DESCRIPTION OF THE INVENTION

The following description provides any person skilled in the art to make and use the invention and sets forth the best modes contemplated by the inventor of carrying out his invention. Various modifications, however, will remain readily apparent to those skilled in the art.

The present invention relates to a method and a system of facilitating an exchange of information between at least two parties on an electronic network, said network comprising of at least a server and plurality of clients as defined herein, said network containing at least one of said parties' desired, own or both attributes and at least one of the remaining parties' own, desired or both attributes, comprising the steps of i) searching at least desired, own or both attributes of one party from at least own, desired or both attributes of the other or a plurality of other parties' respectively; ii) if a) at least one desired attribute of said one party matches at least one own attribute of said other or a plurality of other parties; or b) at least one own attribute of said one party matches at least one desired attribute of said other or a plurality of other parties; or c) at least one desired attribute of said one party matches at least one own attribute of said other or a plurality of other parties and at least one own attribute of said one party matches at least one desired attribute of said other or a plurality of other parties, iii) then transmitting one or a plurality of notifications identifying said one or a plurality of matched parties to said one party.

The present invention also relates to a system for facilitating an exchange of information between at least two parties on an electronic network comprising of at least a server connected to the said network, at least two clients as defined herein, said clients connected to said network and at least a program executing on said network, said network containing at least one of said parties' desired, own or both attributes and at least one of the remaining parties' own, desired or both attributes, such that if a) at least one desired attribute of said one party matches at least one own attribute of said other or a plurality of other parties; or b) at least one own attribute of said one party matches at least one desired attribute of said other or a plurality of other parties; or c) at least one desired attribute of said one party matches at least one own attribute of said other or a plurality of other parties and at least one own attribute of said one party matches at least one desired attribute of said other or a plurality of other parties, one or a plurality of notifications identifying said one or a plurality of matched parties is transmitted to said one party.

The network used in the present invention contains at least a server and plurality of clients. These clients may be computers, mobile phones, or any other electronic devices used in communication.

The parties to the present invention are members of the network. The network contains any of the following information of these parties, viz. their own attributes, desired attributes or both of these attributes. The attributes can be selected from any of the following list, viz. age, gender, location, religion or any combination thereof. However, the selection of the aforesaid attributes is on personal choice and therefore the present invention can be practiced including any other attributes, which have not been disclosed, without departing from the scope and the spirit of the said invention.

The invention involves a method and a system in which the two parties need to be online, viz. on the network (logged on to the server). The program running on the network is at least a software executing on server. A firmware or a software may be executing on the clients.

The aforesaid method is preferably conducted substantially at the instance of the one party available online on the network. Particularly, the searching and transmission of notifications is performed substantially at the instance of the one party available online on the network.

The notifications transmitted are either a visual, aural or tactile signals, or a combination thereof.

A list is created for each of these parties at the instance of the other matched parties being available on the network. This list contains the matched parties who are available on the network (online). This list is updated substantially constantly. Any new party becoming available online, who is a match to the other party is added to the other party's list. This data addition for the new party remains on the other party's list as long as the matched party is available online. Therefore, this list is maintained as long as the matched parties are available on said network.

The aforesaid method is performed on one or more servers located on one or more electronic networks. The networks comprise of a local area network (LAN), wide area network (WAN), Internet, cellular, wireless network, etc.

Another embodiment of the present invention relates to a method of facilitating an exchange of information between one party and other or plurality of other parties on an electronic network, said network comprising of at least a server and plurality of clients as defined herein, said network containing a pre-computed list of other or a plurality of other parties with at least one desired attribute of said one party matched with at least one own attribute of said other or a plurality of other parties; or at least one own attribute of said one party matched with at least one desired attribute of said other or a plurality of other parties; or at least one desired attribute of said one party matched with at least one own attribute of said other or a plurality of other parties and at least one own attribute of said one party matched with at least one desired attribute of said other or a plurality of other parties; or a combination thereof, wherein if at least said other or a plurality of said other parties on said list is available on said network, one or a plurality of notifications identifying said other or a plurality of matched parties is transmitted to said one party.

Further, the present invention speaks about a system for facilitating an exchange of information between one party and other or plurality of other parties on an electronic network comprising of at least a server connected to the said network, at least two clients as defined herein, said clients connected to said network and at least a program executing on the said network, said network containing a pre-computed list of one or a plurality of other parties with at least one desired attribute of said one party matched with at least one own attribute of said other or a plurality of other parties; or at least one own attribute of said one party matched with at least one desired attribute of said other or a plurality of other parties; or at least one desired attribute of said one party matched with at least one own attribute of said other or a plurality of other parties and at least one own attribute of said one party matched with at least one desired attribute of said other or a plurality of other parties; or a combination thereof, wherein if at least said other or a plurality of said other parties on said list is available on said network, one or a plurality of notifications identifying said other or a plurality of matched parties is transmitted to said one party.

While the detailed description and the drawings included in this patent application are prepared with respect to currently prevailing computer, cellular or other electronic networks, it will be evident to anyone skilled in common art that this invention can be practiced on other types of electronic or digital networks, which may or may not have been invented as on date of filing of this application, without departing from the scope and the spirit the said invention.

The said invention is generally described as follows:

The first party logs on to the server. The first party is added to the list of online parties. There are other parties online on the server. The said first party's information data is available on the database of the server. The information data comprises of the party's own attributes and the desired attributes for the party's match. A software is executing on the server. A software or firmware is executing on the clients. The said database contains similar type of information data of all the parties, who are logged on to the server. When the first party logs on to the server, the invention searches the first party's desired attributes from the other parties' own attributes. If at least one of the first party's desired attributes matches any of the other parties' own attributes, a notification is transmitted identifying the matched parties to the first party. A similar notification identifying the first party is substantially simultaneously transmitted to the one or plurality of matched parties.

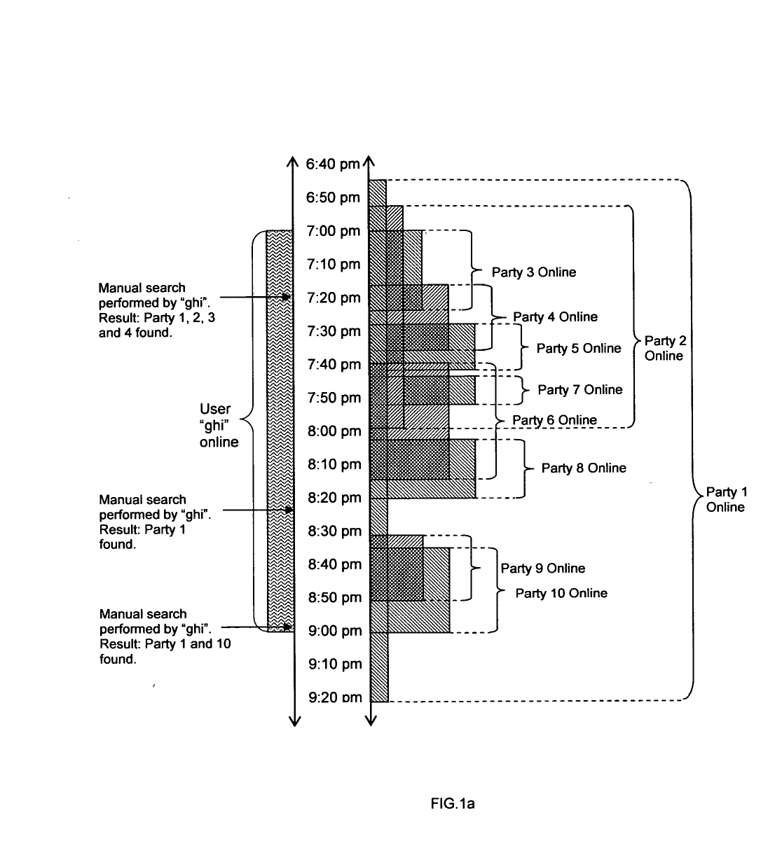

Referring to FIG. 1b, “ghi” comes online at 7 pm. “ghi's” desired and own attributes are matched with own and desired attributes of all the parties online at that time respectively (including Party 1). “ghi's” desired attributes match the own attributes of Party 1 (making Party 1 a direct match of “ghi” and “ghi” a reverse match of Party 1). “ghi” is notified of Party 1 being online. Similarly, Party 1 is notified of “ghi” coming online.

Party 4 comes online at 7:15 pm. Party 4's desired and own attributes are matched with own and desired attributes of all the parties online at that time respectively (including “ghi”). “ghi's” own attributes match the desired attributes of Party 4 (making Party 4 a reverse match of “ghi” and “ghi” a direct match of Party 4). “ghi” is notified of Party 4's coming online. Similarly Party 4 is notified of “ghi” being online.

Party 6 comes online at 7:40 pm. Party 6's desired and own attributes are matched with own and desired attributes of all the parties online at that time respectively (including “ghi”). “ghi's” own attributes match the desired attributes of Party 6 and Party 6's own attributes match the desired attributes of “ghi” (making Party 6 and “ghi” cross matches of each other). “ghi” is notified of Party 6's coming online. Similarly Party 6 is notified of “ghi” being online.

Party “ghi” doesn't have to manually search for his matches, as he is dynamically notified of each and every match, as and when they come online respectively, giving him the opportunity to communicate with all of them. The present invention spares him the effort of searching for his matches (as there is no manual search happening), while expanding his reach to all the matches who come online in the same period as prior art shown in Drawing Sheet 1a.

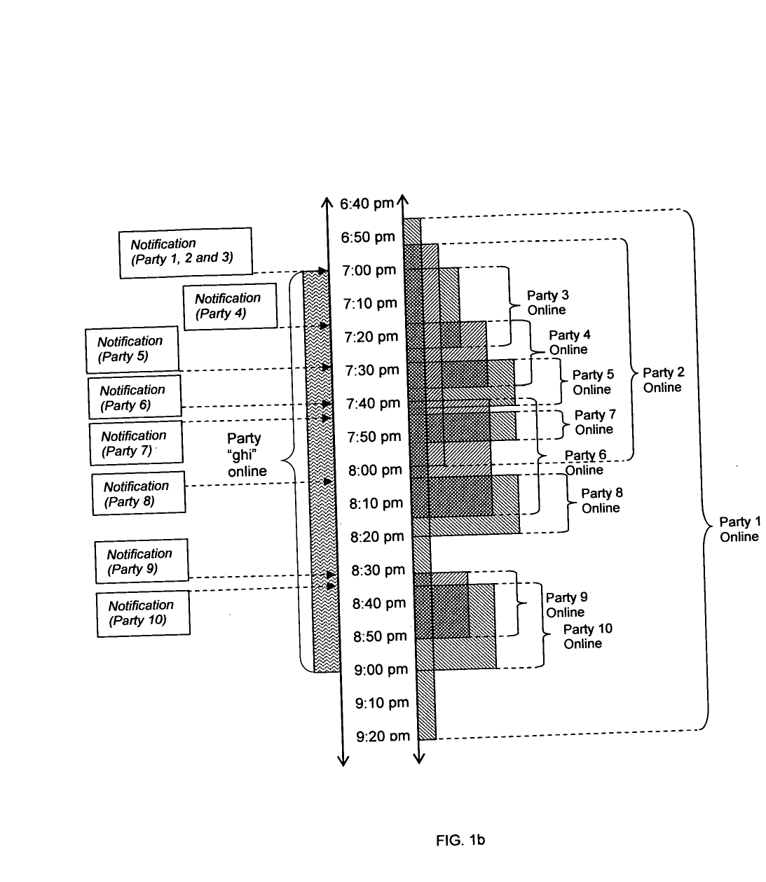

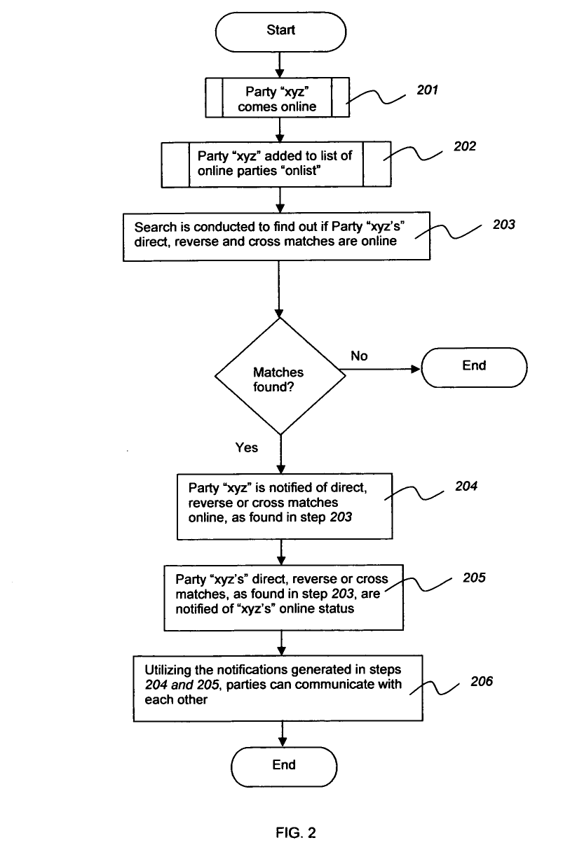

FIG. 2 shows flow chart showing “xyz's” matchmaking and notification process. Referring to FIG. 2, party “xyz” comes online—201. He is added to the list of online parties' “onlist”—202. His information data comprises of his own attributes and the desired attributes for his match. There are other parties online on the said server. The “onlist” also contains the information data (own attributes and desired attributes) of all the online parties. At the instance of “xyz” coming online, the system searches for “xyz's”—direct, reverse and cross matches—203. The concept of ‘direct match, reverse match and cross match’ is later explained with reference to FIGS. 3, 4 and 5 respectively. If at least one of the aforesaid matches is found, a notification—204 is transmitted to “xyz” identifying the matches (direct, reverse or cross) to him. Similarly, the matched party (direct, reverse or cross)—is also notified—205 about “xyz”.

Utilizing these notifications, any of the parties mentioned above can communicate with each other—206.

To utilize this service, all “xyz” has to do, is keep himself available online. Once available online, he can do other tasks and need not actively participate in the match finding process, except responding to the notifications transmitted by the system—204 and 205, saving him valuable time & effort.

As there is no fixed time when direct, reverse or cross match(es) become available online, the prompting system comes handy in netting a very high number of probable matches who come online—Drawing Sheet 1b, resulting in availing him with a high number of relevant matches.

FIG. 3 is an illustration showing that party “abc's” direct match is party “xyz”, by matching the desired attributes of “abc” with own attributes of “xyz”.
“abc” is 23 year old female. Her religion is Hindu. She is an Engineer. Her qualification is Bachelor of Engineering (B.E). She is looking for a 23 to 26 years old Hindu male, whose qualification is either Bachelor of Engineering (B.E.) or Bachelor of Science (B.Sc.) and occupation is Engineer.
“xyz” is 24 year old male. His religion is Hindu. He is a Civil Engineer. His qualification is Bachelor of Engineering (B.E). He is looking for a 20 to 24 years old Hindu female whose qualification is Bachelor of Laws (L.L.B), Bachelor of Engineering (B.E.), or Bachelor of Science (B.Sc.) and occupation is either Advocate or Engineer.

As the desired attributes of “abc” match the own attributes of “xyz”, “xyz” is a direct match of “abc”.

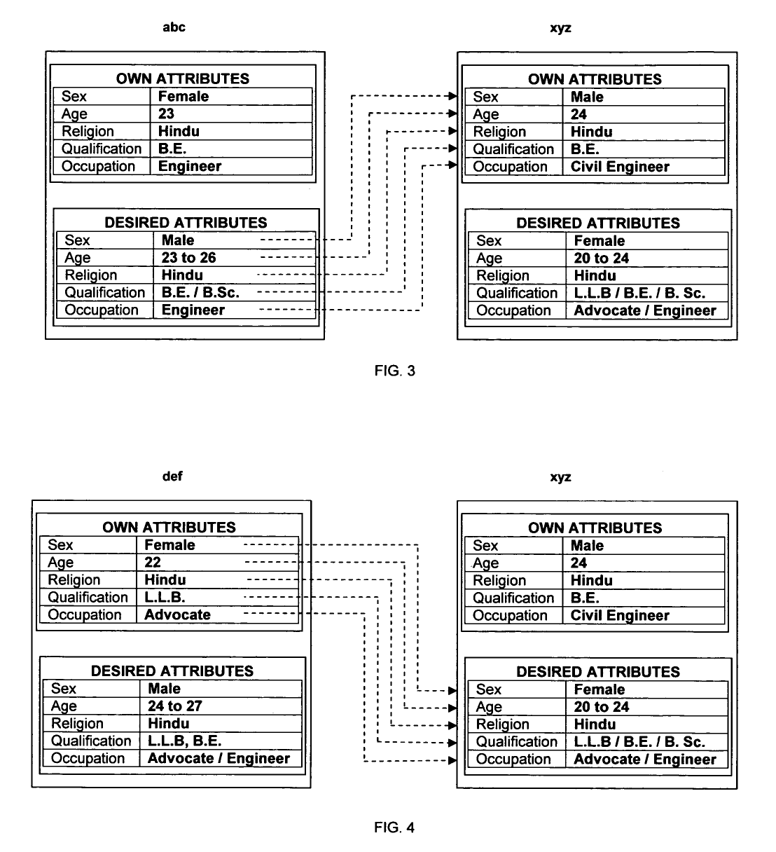

FIG. 4 is an illustration showing that party “def's” reverse match is party “xyz”, by matching the own attributes of def with desired attributes of xyz.
“def” is 22 year old female. Her religion is Hindu. She is an Advocate. Her qualification is Bachelor of Laws (L.L.B). She is looking for a 24 to 27 years old Hindu male, whose qualification is Bachelor of Laws (L.L.B) or Bachelor of Engineering (B.E.) and occupation is either Advocate or Engineer.
“xyz” is 24 year old male. His religion is Hindu. He is a Civil Engineer. His qualification is Bachelor of Engineering (B.E). He is looking for a 20 to 24 years old Hindu female whose qualification is Bachelor of Laws (L.L.B), Bachelor of Engineering (B.E.), or Bachelor of Science (B.Sc.) and occupation is either Advocate or Engineer.

As the own attributes of def match the desired attributes of “xyz”, “xyz” is a reverse match of “def”.

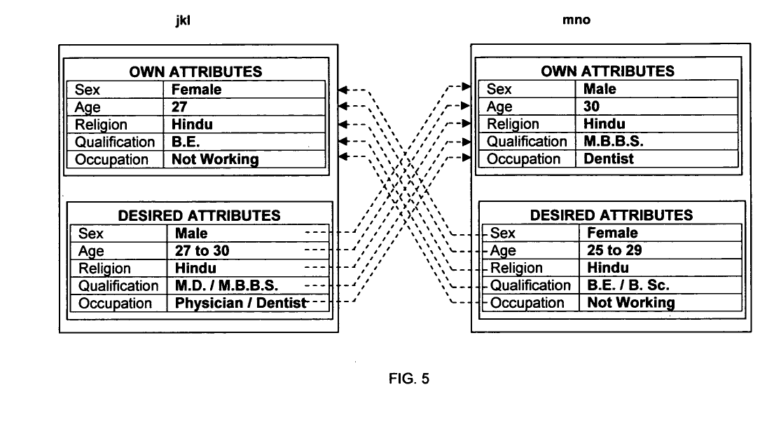

FIG. 5 is an illustration showing that party “jkl” and party “mno” are cross matches of each other, by matching the desired attributes of “jkl” with own attributes of “mno” and by matching the desired attributes of “mno” with own attributes of “jkl”.
“jkl” is 27 year old female. Her religion is Hindu. She is not working (occupation). Her qualification is Bachelor of Engineering (B.E). She is looking for a 27 to 30 years old Hindu male whose qualification is either Doctor of Medicine (M.D.) or Bachelor of Medicine and Bachelor of Surgery (M.B.B.S.) and occupation is either Physician or Dentist.
“mno” is 30 year old male. His religion is Hindu. He is a Dentist. His qualification is Bachelor of Medicine and Bachelor of Surgery (M.B.B.S.). He is looking for a 25 to 29 years old Hindu female whose qualification is either Bachelor of Engineering (B.E.) or Bachelor of Science (B.Sc.) and is not working (occupation).

As “jkl's” desired attributes match “mno's” own attributes and as “mno's” desired attributes match “jkl's” own attributes, “jkl” and “mno” are cross matches of each other.

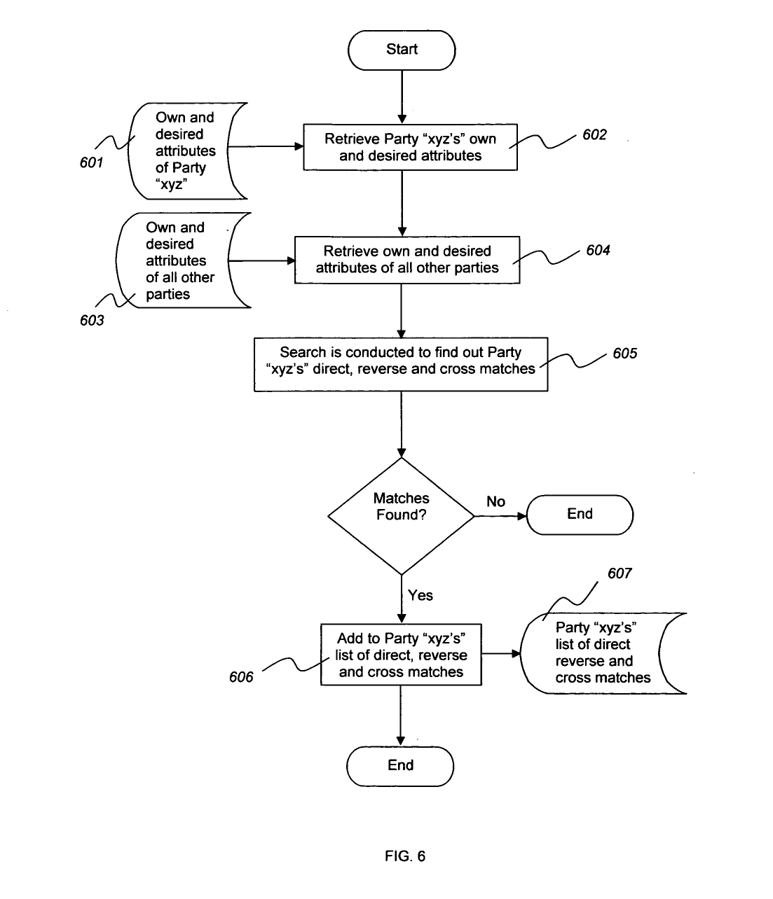

FIG. 6 is a flow chart showing the process of generating a pre-computed list of Party “xyz's” direct, reverse and cross matches. Referring to FIG. 6, party “xyz's” own and desired attributes are retrieved—602 from a data source—601. Next, the own and desired attributes of all other parties are retrieved—604 from the same or another data source—603. The system searches for “xyz's” direct, reverse and cross matches—605. If the aforesaid matches are found, the aforesaid matches are added—606 to party “xyz's” list of direct, reverse and cross matches respectively—607.

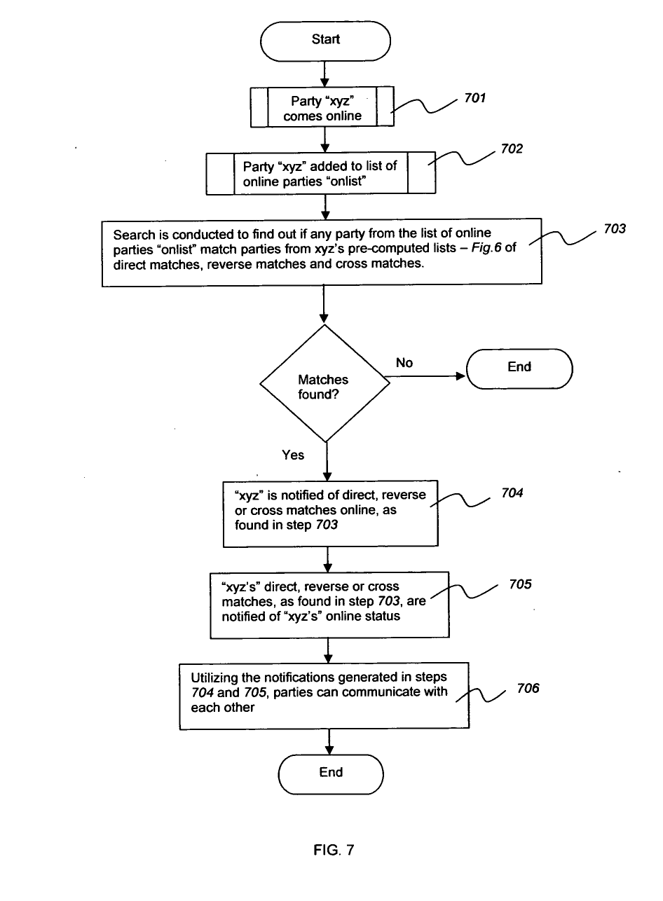

FIG. 7 is a flowchart showing party “xyz's” matchmaking and notification process using a pre-computed list. Referring to FIG. 7, party “xyz” comes online—701. He is added to the list of online parties “onlist”—702. The network contains a pre-computed list of “xyz's” direct, reverse and cross matches—703. At the instance of “xyz” coming online, the system searches for “xyz's” direct, reverse and cross matches from the aforesaid pre-computed list—703. If at least one of the aforesaid matches is found, a notification—704 is transmitted to “xyz” identifying the matches (direct, reverse or cross) to him. Similarly, the matched party (direct, reverse or cross)—is also notified—705 about “xyz”.

Utilizing these notifications, any of the parties mentioned above can communicate with each other—706.

Those skilled in the art will appreciate that various adaptations and modifications of the afore-described preferred embodiment can be configured without departing from the scope and spirit of the invention. Therefore, it is to be understood that, within the scope of the appended claims, the invention may be practiced other than as specifically described herein.

1. A method of facilitating an exchange of information between at least two parties on an electronic network, said network comprising of at least a server and plurality of clients as defined herein, said network containing at least one of said parties' desired, own or both attributes and correspondingly at least one of the remaining parties' own, desired or both attributes, comprising the steps of:
i) searching at least desired, own or both attributes of one party from at least corresponding own, desired or both attributes of the other or a plurality of other parties';
ii) if:
a) at least one desired attribute of said one party matches at least one own attribute of said other or a plurality of other parties; or
b) at least one own attribute of said one party matches at least one desired attribute of said other or a plurality of other parties; or
c) at least one desired attribute of said one party matches at least one own attribute of said other or a plurality of other parties and at least one own attribute of said one party matches at least one desired attribute of said other or a plurality of other parties,
iii) then transmitting one or a plurality of notifications identifying said other or a plurality of matched parties to said one party.

2. A method as claimed in claim 1, wherein said searching is conducted substantially at the instance of said one party available on said network.

3. A method as claimed in claim 2, wherein said one or a plurality of notifications is transmitted substantially at the instance of said one party available on said network.

4. A method as claimed in claim 1, wherein a notification identifying said one party is substantially simultaneously transmitted to said other or a plurality of matched parties.

5. A method of facilitating an exchange of information between one party and other or plurality of other parties on an electronic network, said network comprising of at least a server and plurality of clients as defined herein, said network containing a pre-computed list of other or a plurality of other parties with:
a) at least one desired attribute of said one party matched with at least one own attribute of said other or a plurality of other parties; or
b) at least one own attribute of said one party matched with at least one desired attribute of said other or a plurality of other parties; or
c) at least one desired attribute of said one party matched with at least one own attribute of said other or a plurality of other parties and at least one own attribute of said one party matched with at least one desired attribute of said other or a plurality of other parties; or
d) a combination thereof,
wherein if at least said other or a plurality of said other parties on said list is available on said network, one or a plurality of notifications identifying said other or a plurality of matched parties is transmitted to said one party.

6. A method as claimed in claim 5, wherein said one or a plurality of notifications is transmitted substantially at the instance of said one party available on said network.

7. A method as claimed in claim 5, wherein a notification identifying said one party is substantially simultaneously transmitted to said other or a plurality of matched parties.

8. A method as claimed in any of the aforesaid claims, wherein said attributes include at least age, gender, location, religion, or a combination thereof.

9. A method as claimed in any of the aforesaid claims, wherein said notification is at least visual, aural or tactile signal, or a combination thereof.

10. A method as claimed in any of the aforesaid claims, further comprising of creating a list for each of said parties at the instance of at least the other or plurality of matched parties available on said network, said list containing at least a matched party for each of said parties, said list being maintained as long as said matched parties are available on said network.

11. A method as claimed in any of the aforesaid claims, wherein said method is performed on one or more servers located on one or more electronic networks.

12. A method as claimed in any of the aforesaid claims, wherein said network comprises of at least a local area network (LAN), wide area network (WAN), Internet, cellular, wireless network, or a combination thereof.

13. A system for facilitating an exchange of information between at least two parties on an electronic network comprising of at least a server connected to the said network, at least two clients as defined herein, said clients connected to said network and at least a program executing on said network, said network containing at least one of said parties' desired, own or both attributes and correspondingly at least one of the remaining parties' own, desired or attributes, such that if:
a) at least one desired attribute of said one party matches at least one own attribute of said other or a plurality of other parties; or
b) at least one own attribute of said one party matches at least one desired attribute of said other or a plurality of other parties; or
c) at least one desired attribute of said one party matches at least one own attribute of said other or a plurality of other parties and at least one own attribute of said one party matches at least one desired attribute of said other or a plurality of other parties,
one or a plurality of notifications identifying said one or a plurality of matched parties is transmitted to said one party.

14. A system as claimed in claim 13, wherein said one or a plurality of notifications is transmitted substantially at the instance of said one party available on said network.

15. A system as claimed in claim 13, wherein a notification identifying said one party is substantially simultaneously transmitted to said other or a plurality of other parties.

16. A system for facilitating an exchange of information between one party and other or plurality of other parties on an electronic network comprising of at least a server connected to the said network, at least two clients as defined herein, said clients connected to said network and at least a program executing on the said network, said network containing a pre-computed list of one or a plurality of other parties with
a) at least one desired attribute of said one party matched with at least one own attribute of said other or a plurality of other parties; or
b) at least one own attribute of said one party matched with at least one desired attribute of said other or a plurality of other parties; or
c) at least one desired attribute of said one party matched with at least one own attribute of said other or a plurality of other parties and at least one own attribute of said one party matched with at least one desired attribute of said other or a plurality of other parties; or
d) a combination thereof,
wherein if at least said other or a plurality of said other parties on said list is available on said network, one or a plurality of notifications identifying said other or a plurality of matched parties is transmitted to said one party.

17. A system as claimed in claim 16, wherein said one or a plurality of notifications is transmitted substantially at the instance of said one party available on said network.

18. A system as claimed in claim 16, wherein a notification identifying said one party is substantially simultaneously transmitted to said other or a plurality of matched parties.

19. A system as claimed in any of the claims 13 to 18, wherein said program is at least a software executing on said server.

20. A system as claimed in any of the claims 13 to 19, further comprising of at least a firmware or a software executing on said clients.

21. A system as claimed in any of the claims 13 to 20, wherein said attributes include at least age, gender, location, religion, or a combination thereof.

22. A system as claimed in any of the claims 13 to 21, wherein said notification is at least a visual, aural or tactile signals, or a combination thereof.

23. A system as claimed in any of the claims 13 to 22, wherein one or more servers are located on one or more electronic networks.

24. A system as claimed in any of the claims 13 to 23, wherein said network comprises of at least a local area network (LAN), wide area network (WAN), internet, cellular, wireless network, or a combination thereof.
